(19) United States
(12) Patent Application Publication
(10) Pub. No.: US 2002/0190453 A1
(43) Pub. Date: Dec. 19, 2002

(54) Coated spring and method of making the same

(75) Inventors: Grant A. Wilhelm, Plymouth, MN (US); Jaime Erickson, Farmington, MN (US)

Correspondence Address: MERCHANT & GOULD PC, P.O. BOX 2903, MINNEAPOLIS, MN, 55402-0903, US

(73) Assignee: COLDER PRODUCTS COMPANY, ST. PAUL, MN (US)

(21) Appl. No.: 10/172,195

(22) Filed: Jun. 14, 2002

Related U.S. Application Data
(60) Provisional application No. 60/298,739, filed on Jun. 15, 2001.

(51) Int. Cl. B60G 11/14

(52) U.S. Cl. 267/248

(57) ABSTRACT

This invention is related to coated springs. More particularly, this invention is a coated spring having a coating that is a dual heat shrinkable material. Further, a method for producing a coated spring with sealed ends or sealed capped ends using the same dual heat shrinkable material.

This application claims the benefit of U.S. Provisional Application No. 60/298,739, entitled COATED SPRING AND METHOD OF MAKING THE SAME, filed Jun. 15, 2001, and is incorporated herewith by reference in its entirety.

### FIELD OF THE INVENTION

This invention is related to coated springs. More particularly this invention is related to a coated spring including a dual heat-shrinkable material and a method for making a coated spring having a dual heat-shrinkable material.

### BACKGROUND OF THE INVENTION

Springs are well known and widely used. One application where springs are often used is in fluid and media transfer, such as in coupling valves for biasing the valves into an open and closed position, for example, in semiconductor processing. Springs are employed in many types of environments, such as chemically hostile environments. Often when used in chemically hostile environments, it is important that a suitable protective coating be used to prevent corrosion of these springs. Typically, protective coating materials have been used to protect such springs from extreme environments. In the past, these protective coatings have been applied to a formed spring by spraying or dipping techniques. However, such methods have produced springs with non-uniform coatings, poor annealing between the spring and its protective coating material, possible connected coils, and moisture trapped between the spring and the inner surface of the protective coating material.

U.S. Pat. No. 3,711,917 to Baumgras produced a coated spring which included a heat-shrinkable protective material. Here, a metal wire inserted into its protective material is formed as a unit into the desired spring conformation. Following formation of the spring, a heating element moves from one end to the other end, thereby progressively heat shrinking the spring to completion. Baumgras says in this way, the increased temperature achieves spring temper, relieves the stress of the now formed “half-hard” spring material, expels moisture, and simultaneously shrinks the protective material to snugly encompass the spring material. However, Baumgras presents other problems where a spring is not properly coated at its ends, and pin holes may form at the exposed ends. Further, as the spring is coiled after formation the ends may be damaged by tooling during the coiling process.

Therefore, there is a need to produce a spring with a protective coating where the ends of such spring are properly coated, and where the coated spring may be easily formed without damage to the protective coating.

### SUMMARY OF THE INVENTION

In accordance with the present invention, the above and other problems were solved by providing a coated spring and a method for making a coated spring, where a dual heat shrinkable protective coating material is used.

In one embodiment of the present invention, a coated spring includes an inner wire spring material, and an outer protective coating material made of a dual heat shrinkable material, wherein the dual heat shrinkable material has an inner layer and an outer layer, wherein the inner layer has a material with a lower heat resistance than the material of the outer layer. The coated spring includes first and second ends each having the dual heat shrinkable material providing sealed end portions.

In another embodiment of the present invention, a method for making a coated spring includes providing a wire spring material and a protective coating material composed of a dual heat shrinkable material, wherein the dual heat shrinkable material has an inner layer and an outer layer, wherein the inner layer has a material with a lower heat resistance than the material of the outer layer. The protective coating material and the wire spring material are wound in the same orientation. The wound wire spring material is threaded into the wound protective coating material such that the protective coating material has a first end portion and a second end portion extending a length beyond a first and second end of the wire spring material to be formed as sealed end portions for the coated spring ends, respectively. The wire spring material threaded into the protective coating material is heated, thereby shrinking the protective coating material to the wire spring material. A seal is produced between the protective coating material and the wire spring. At the ends, the heat shrinking seals the first and second ends of the coated spring at end portions made of the dual heat shrinkable protective coating material portions extended beyond the ends of the wire spring material.

In yet another embodiment of the present invention, a method for making a coated spring includes providing a wire spring material and a protective coating material of a dual heat shrinkable material, wherein the dual heat shrinkable material has an inner layer and an outer layer, wherein the inner layer has a material of a lower heat resistance than the material of the outer layer, and sliding the wire spring material into the dual heat shrinkable protective coating material. Together the wire spring material and the protective coating material are subjected to a first shrinking where the protective coating material is sealed to the wire spring material. After the wire spring material and protective coating material are sealed together by heating, they are wound to form the spring configuration, and the coated spring is then stress relieved by heating. A length of protective coating material is attached at each end of the coated spring to cover each end and is extended a length beyond each end to later be formed as end caps for the coated spring. The spring is subjected to a second heat shrinking wherein the second heat shrinking seals the ends of the coated spring as sealed end portions or end caps made of the dual heat shrinkable material.

An advantage of the present invention provides a coated spring with excellent chemical resistant and heat resistant properties where the ends of the coated spring are properly sealed. Further, the method of the present invention allows for a more convenient way to produce a coated spring without damaging the protective coating intended for such a spring.

These and other various advantages and features of novelty, which characterize the invention, are pointed out in the following detailed description. For better understanding of the invention, its advantages, and the objects obtained by its use, reference should also be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1a represents a side view of one embodiment for a coated spring in accordance with the principles of the present invention.

FIG. 1b represents a perspective view of the coated spring in FIG. 1a.

FIG. 1c represents a front view of the coated spring in FIG. 1a.

FIG. 2a represents a side view of another embodiment for a coated spring in accordance with the principles of the present invention.

FIG. 2b represents a perspective view of the coated spring in FIG. 2a.

FIG. 2c represents a front view of the coated spring in FIG. 2a.

FIG. 3 represents a partial cross-sectional view of an embodiment for a coated spring in accordance with the principles of the present invention.

FIG. 4 represents a partial cross-sectional view of another embodiment of a coated spring in accordance with the principles of the present invention.

FIG. 5 represents a schematic diagram of an embodiment of a method for coating springs in accordance with the principles of the present invention.

FIG. 6 represents a schematic diagram of another embodiment of a method for coating springs in accordance with the principles of the present invention.

FIG. 7 represents a block flow diagram of an embodiment for a method of making a coated spring in accordance with the principles of the present invention.

FIG. 8 represents a block flow diagram of another embodiment for a method of making a coated spring in accordance with the principles of the present invention.

### DETAILED DESCRIPTION OF THE PREFERRED EMBODIMENT

In the following description of the illustrated embodiments, reference is made to the accompanying drawings that form a part hereof, and in which is shown by way of illustration of the embodiments in which the invention may be practiced. It is to be understood that other embodiments may be utilized as structural changes may be made without departing from the spirit and scope of the present invention.

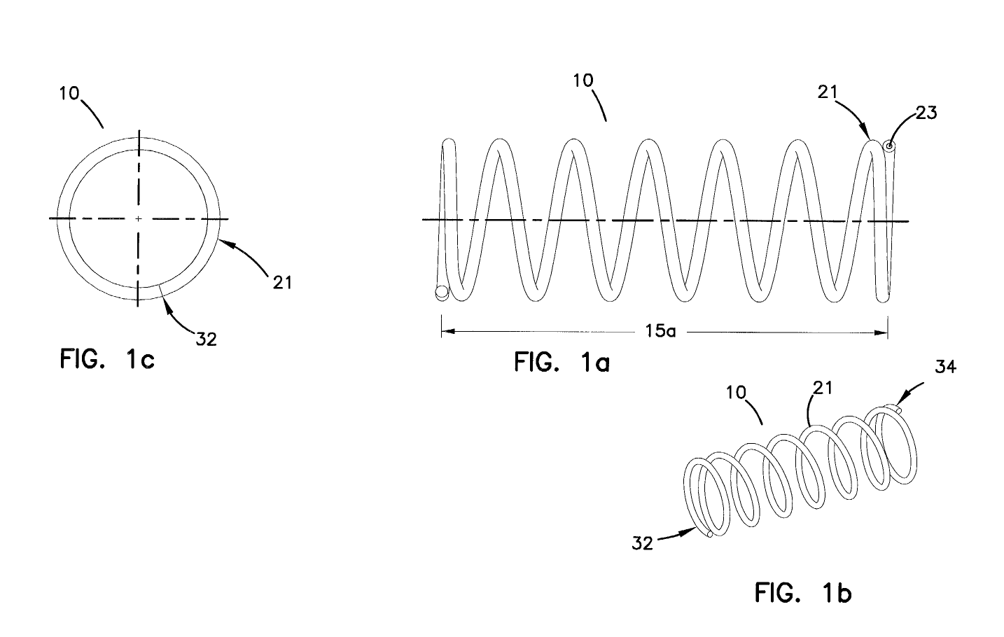

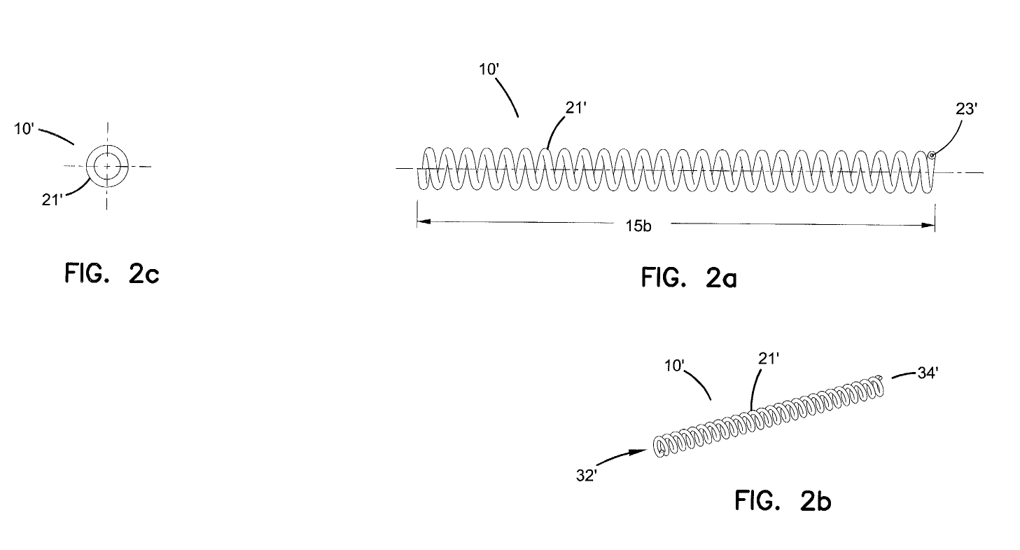

FIGS. 1-2 illustrate exemplary embodiments for a coated spring 10. Particularly shown in FIGS. 1-2, springs employed in accordance with the present invention are used in coupling valves for biasing the valves into an open and closed position for fluid and media transfer applications, such as semiconductor processing. Preferably, these springs may not be more than 2.5 inches in diameter and 4-5 inches in length. However, these dimensions are merely exemplary as other diameters and lengths may used. Further, the orientation and pitch of a spring in accordance with the present invention may vary as appropriate for its application.

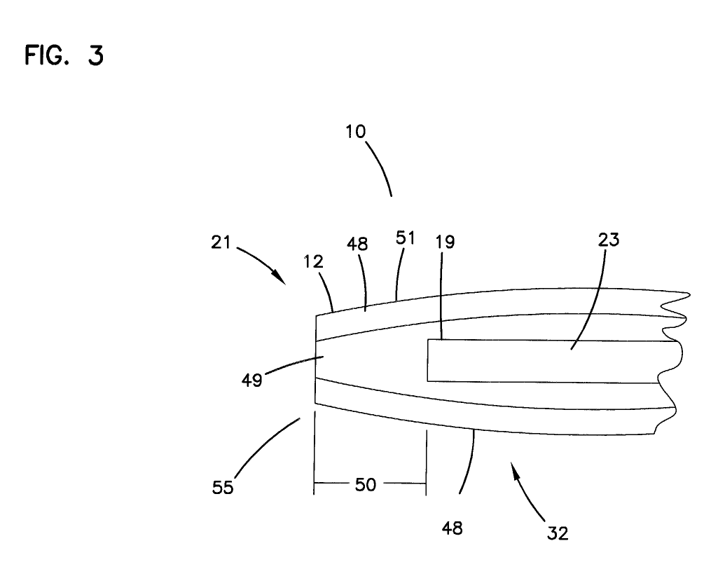

As best shown in FIGS. 1b and 2b, the coated springs 10 and 10′ include a first sealed end 32, 32′ and a second sealed end 34, 34′. An outer protective coating material 21, 21′ is formed and sealed over an inner wire spring material 23, 23′. FIGS. 1a and 2a show the inner wire spring material 23, 23′ for illustration purposes only. It will be appreciated the ends 32, 32′ and 34, 34′ are covered with an outer protective coating, such as 21, 21′, after manufacture and during use. The outer protective coating material 21, 21′ may be made of a dual heat shrinkable material that includes a first outer layer 48 (shown in FIG. 3) possessing excellent chemical and heat resistant properties, and a second inner layer 49 that is less heat resistant than the outer layer 48 (also shown in FIG. 3).

One example of an outer protective coating material may be the dual heat shrink material produced by the company ZEUS, where the outer protective coating material 21 may be a tube made of materials such as polytetrafluoroethylene (PTFE) for the outer layer 48 and fluorinated ethylenepropylene (FEP) for the inner layer 49. However, these materials are merely exemplary and other materials may be used that possess suitable properties for an outer protective coating material 21.

The inner wire spring material 23 may be made of metal. Preferably, the inner wire spring material 23 is a coiled spring. More preferably for the inner wire spring material 23, a metal should be used which also has excellent stress relieving or annealing properties with the outer protective coating material 21. Preferably, stainless steel can be employed for the inner wire spring material 23. However, the present invention is not limited to stainless steel, as other materials may possess the same or better stress relieving properties suitable for the inner wire spring material 23. Lengths 15a and 15b of the coated spring 10 illustrate varying exemplary lengths that are possible for the coated spring 10.

As mentioned above, FIG. 3 illustrates the first sealed end 32 of the coated spring 10 in partial cross section. The coated spring 10 can be seen having the inner wire spring material 23 and the outer protective coating material 21. Further, the outer protective coating material 21 includes an inner layer 49 and an outer layer 48. As can be seen in FIG. 3, the outer protective coating material 21 is provided with the first end 12 having a portion 51 that extends a length 50 past a second end 19 of the inner wire spring material 23. FIG. 3 also illustrates that the first end 12 of the outer protective coating material 21 is sealed 55 with the wire spring material 23 at portion 51. It will be appreciated that the portion 51 may have a length 50 extending beyond the second end 19 of the inner wire spring material 23, and will be sealed with the second end 19.

FIG. 3 illustrates the inner layer 49 seals and covers the second end 19 where the outer layer 48 resides externally and is exposed to the outer environment. When the outer protective coating material 21 is subjected to heat shrinking, the inner layer 49 of the protective coating material 21, which has a lower heat resistance, melts the protective coating material 21 to the inner wire spring material 23 forming a seal with the wire spring material 23. The outer layer 48 possesses excellent chemical resistance properties suitable for protection of the spring 10. Similar structure and sealing would be employed for the first end (not shown) of the wire spring material, thereby achieving a coated spring with ends that are properly sealed.

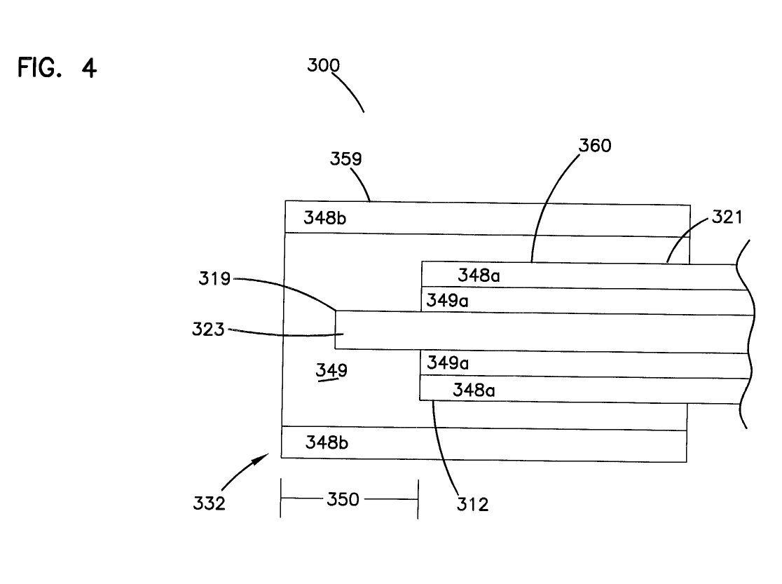

FIG. 4 shows another embodiment of a coated spring in partial cross section illustrating a first sealed end 332 of the coated spring 300. In an alternative where a coated spring 300 contains exposed ends after a first heat shrinking, the second end 319 of the wire spring material 323 is capped with an attached length of dual heat shrinkable material as an end cap 359. The end cap 359 would be of a material making up an inner layer 349b and outer layer 348b similar to a dual heat shrinkable material above. An end cap 359 may be attached and sealed to cover and protect any exposure of both a first end (not shown) and second end 319 of the wire spring material 323 and extend a length 350 beyond the ends of the wire spring material 23. As illustrated in FIG. 4, after a second heat shrinking, a sealed end 332 includes the end cap 359 sealed with the second end 319 of the wire spring material 323, and has an overlapping region 360 where the second dual heat shrinking overlaps and partially covers the first dual heat shrink coating. As shown in FIG. 4, the coated spring may have a greater thickness at the ends where the end caps are formed. The end cap 359 together with the first dual heat shrink coating 348a, 349a form the complete protective coating material for the wire spring material. Similarly, the first end may be sealed with an end cap 359 as above; thereby producing sealed ends.

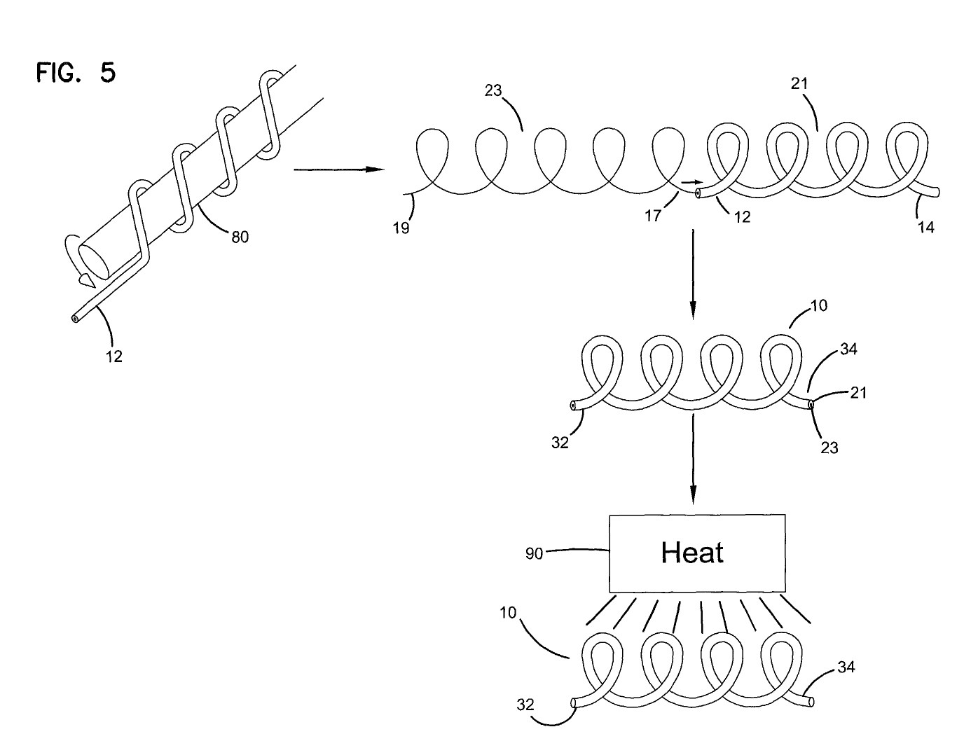

FIG. 5 shows an exemplary schematic of one embodiment of a method 100 for making a coated spring 10. A wire spring material 23 is separately wound, and a mandrel 80 is cleaned. FIG. 5 illustrates the winding of the protective coating 21 on the mandrel 80. The wire spring material 23 is shown being threaded into the wound protective coating material 21. A conformation is formed where the wire spring material 23 is completely inserted into the protective coating material 21 and the protective coating extends a length (shown in FIGS. 3) beyond each of the ends 17 and 19 of the wire spring material 23. A heat source 90 is used to heat shrink the protective coating material 21 to seal the protective coating material 21 to the wire spring material 23, where the ends 17 and 19 of the wire spring material 23 are sealed forming an example of coated spring ends 32, 34. The heat application can also stress relieve the coiled wire spring material 23.

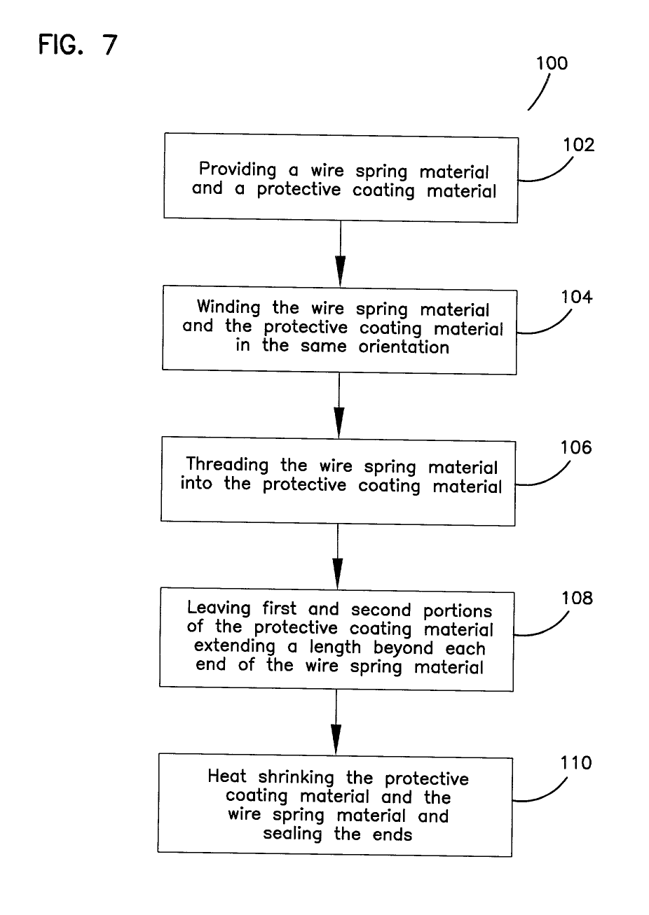

FIG. 7 outlines the method 100, illustrated in FIG. 5, for making a coated spring 10 in the present invention. A wire spring material 23 and a protective coating material 21 that may be a tube made of a dual heat shrinkable material are provided and wound in the same orientation 102, 104. After the wire spring material 23 and the protective coating material 21 are wound into a spring configuration, the wire spring material 23 is threaded into the protective coating material 21 by winding the wire spring material 23 into the protective coating material 21 in step 106. As the orientation of the wire spring material 23 and the protective coating material 21 are the same, the wire spring material 23 may be insertable into the protective coating material 21.

The threading of the wire spring material 23 into the protective coating material 21 is performed where the first end 17 of the wire spring material is wound into the protective coating material 21 towards a second end 14 of the protective coating material 21 until a second end 19 of the wire spring material 23 is flush with a first end 12 of the protective coating material 21. Overlap of the protective coating material 21 at both ends of the coated spring 10 is achieved by employing a protective coating material 21 having a length greater than a length of the wire spring material 23.

When the second end 19 of the wire spring material is flush with the first end 12 of the protective coating material 21, the wire spring material 23 is further threaded into the protective coating material 21 such that a length 50 of the protective coating material 21 is left to extend beyond the second end 19 of the wire spring material 23 in step 108. A length of at least 0.5 inches may be left extended over each of the ends 17, 19 of the wire spring material 23 as in step 108. A length of at least 0.5 inches is exemplary, as other lengths may also be used. Further, as a length of the protective coating material 21 at the second end 14 may be considerably longer than the first end 17 of the wire spring material 23 after threading, the protective coating material 21 may need to be cut shorter so as to leave a proper overlap length, such as length 50 in FIG. 3.

The wire spring material 23 and protective coating material 21 are subjected to heat shrinking thereby sealing the protective coating material 21 to the wire spring material 23 in step 110. The heat shrinking may last up to 2 minutes, 45 seconds at a temperature of 660° F. Further, the heat shrinking can also stress relieve the wire spring material 23. However, these conditions are merely exemplary. An end portion 55 of the protective coating material 21 is formed as the dual heat shrink material has an inner material 49 less heat resistant than the outer material 48 allowing the protective coating material 21 to seal to the wire spring material 23.

The ends 32, 34 of the coated spring 10 may be trimmed as needed to leave a length of 0.10-0.15 inches beyond each of the ends of the wire spring material 23. The outer and inner materials 48, 49 may be PTFE and FEP, respectively. However, any suitable materials could be employed that possess similar properties. The wire spring material 23 is preferably a stainless steel material having excellent stress relieving or annealing properties, but this is only exemplary and other metals may be used as long as the stress relieving properties are suitable.

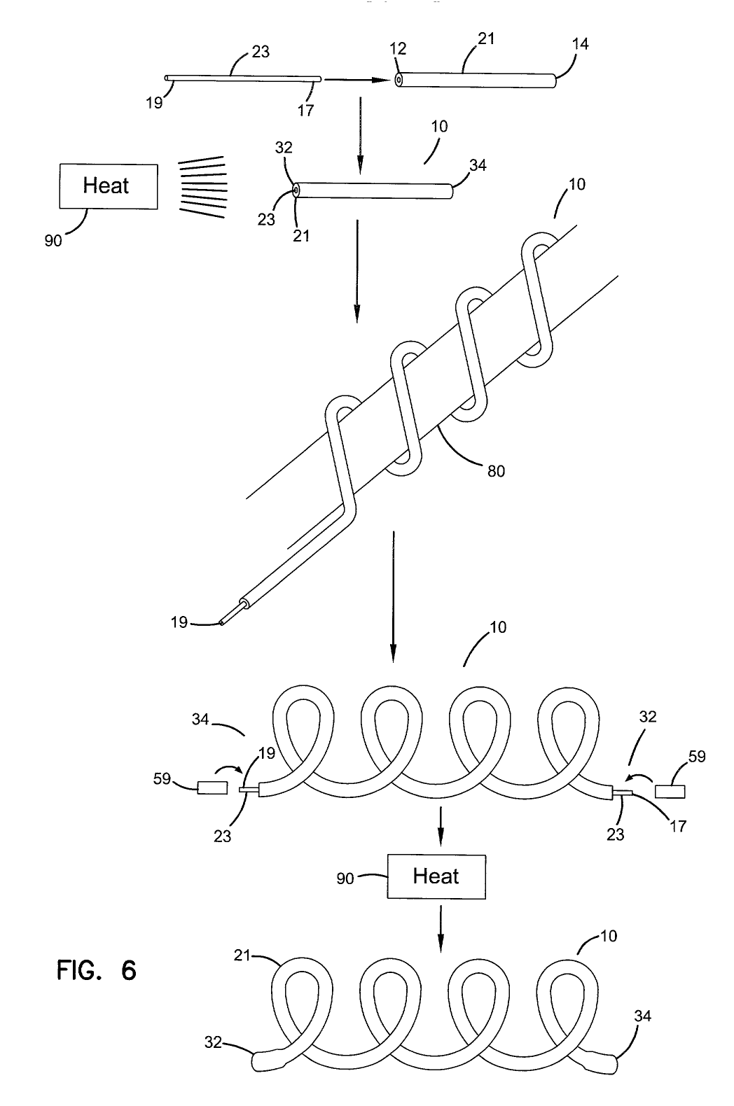

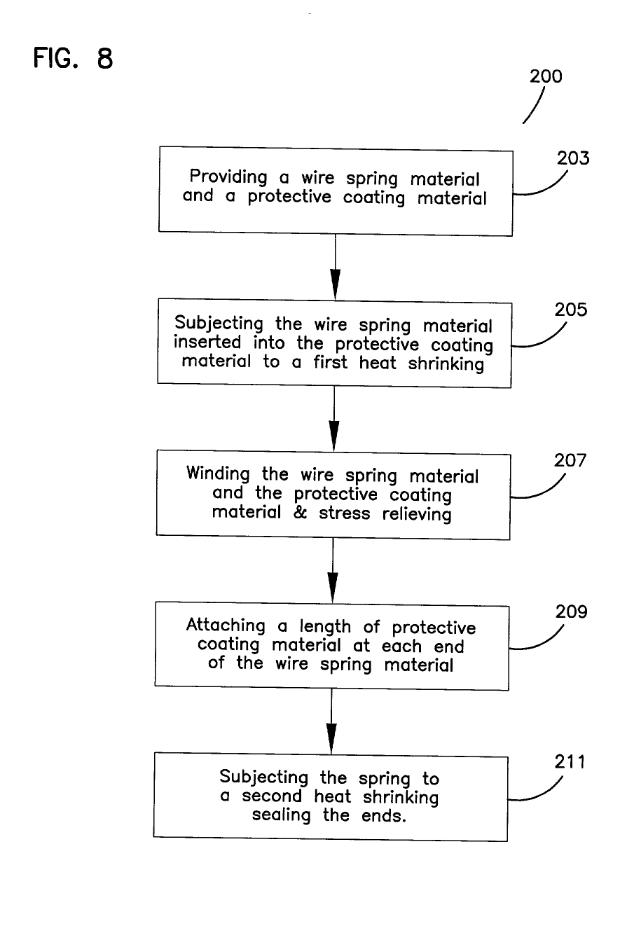

FIG. 6 shows an exemplary schematic of another embodiment for a method 200 (FIG. 8) for making a coated spring. Preferably the coated spring formed by the method illustrated in FIGS. 6 and 8 is similar to the coated spring of FIG. 4. A wire spring material 23, a dual shrinkable protective coating material 21, and a mandrel 80 are cleaned. FIG. 6 illustrates a wire spring material 23 that is to be inserted into a protective coating material 21 that may be in the form of a tube, such as a straight cylindrical tube. A heat source 90 is used to heat shrink the protective coating material 21 onto the wire spring material 23. The wire spring material 23 with its protective coating material 21 sealed thereon is then subjected to tooling, using an instrument such as a mandrel 80, so as to wind the coated spring 10 into a spring conformation. The coated spring 10 is then stress relieved, such as by heating. It will be appreciated that other methods also may be suitable for stress relieving. Ends 17, 19 of the wire spring material 23 may be exposed by the tooling during the coiling process. End caps 59 of a dual heat shrink material are attached to the ends 17, 19 of the wire spring material 23. A second heat shrinking is performed with the heat source 90 to heat shrink the end caps 59, thereby covering and sealing the ends 17, 19 and forming completely coated spring ends 32, 34. Preferably, the end caps 59 extend a length, such as length 350 (FIG. 4) beyond the ends 17, 19 of the wire spring material 21, and may overlap the dual heat shrinkable material from the first heat shrinking. As shown in FIGS. 4 and 6, the coated spring may have a greater thickness at the ends where the end caps are formed.

FIG. 8 outlines another embodiment of a method 200 for making a coated spring 10 in the present invention. As above in FIG. 6 a wire spring material 23 and a protective coating material 21 made of a dual heat shrink material are provided 203. Further the wire spring material 23 is inserted into the protective coating material 21 before being wound. The wire spring material 23 inside the protective coating material 21 is subjected to a first heat shrinking sealing the wire spring material 23 and the protective coating material 21 in step 205.

The coated spring 10 is then wound into a spring configuration and the coated spring 10 is stress relieved 207. The ends 17, 19 of the wire spring material 23 may be exposed at this point. Therefore another length of dual heat shrinkable protective coating material 21 is attached at both ends 17, 19 of the wire spring material 23 in step 209 as end caps as described above. Preferably, a length of 1.0 inches is attached at each of the ends 17, 19 of the wire spring material 23 where a length at least of 0.5 inches is left extended past each of the ends of the wire spring material having the protective coating 321 applied thereon after a second heat shrinking (211 below). However these lengths are exemplary and other lengths may be used as appropriate for the application.

The ends 17, 19 may be inserted into the end caps having the length of dual heat shrinkable material. The coated spring 10 is subjected to a second heat shrinking 211 where the ends 17, 19 are sealed and capped having a length, such as length 350 in FIG. 5, of protective coating material attached, thereby forming an example of coated spring ends 32, 34. In this configuration, the end caps and the first protective coating form a spring that is completely coated and sealed with the protective material. Therefore, if any damage were to occur to the coating at the coated spring ends 32, 34 from being wound after the first heat shrinking, the subsequent heat shrinking would repair any damage to the coating of the spring.

This method 200 may be more useful for manufacturing springs having longer lengths, a higher number of coils, and a smaller diameter (FIG. 2a-c). The ends 17, 19 may also be capped employing injection molding and dipping techniques. However, similar shortcomings as indicated above may be encountered by employing such alternatives.

Similarly as above, the first and second heat shrinking may last up to 2 minutes, 45 seconds at a temperature of 660° F. However, these conditions are merely exemplary. The sealed end portions of the protective coating material 21 are formed with the dual heat shrink material having an inner layer 49 with a material that is less heat resistant than the outer material of the outer layer 48. The end caps may be trimmed as needed to leave a length of the outer protective coating material of 0.30-0.60 inches beyond each of the wire spring material ends 17, 19. These lengths are merely exemplary as other lengths may also be used. As defined above, the outer and inner materials, such as 348a, 349a and the end caps 348b, 349b may be PTFE and FEP, respectively. However, any suitable materials could be employed that possess similar properties. The wire spring material 323 is preferably a stainless steel material having excellent annealing properties, but this is only exemplary and other metals may be used as long as the annealing properties are suitable.

The advantages provided by the present invention include a coated spring where the ends are properly sealed. Further, the employment of a dual heat shrink material allows the coated spring to possess excellent chemical and heat resistant properties in its outer material while still allowing the inner layer to melt and form a seal at each end of the spring. This way the protective material of the coated spring would not be subjected to pin holes. Further, by heat shrinking after the forming the spring configuration allows for a more convenient and improved method of making a coated spring where the protective coating material is not damaged.

Having described the embodiments of the present invention, modifications and equivalents may occur to one skilled in the art. It is intended that such modifications and equivalents shall be included with the scope of the invention.

We claim:

1. A coated spring, comprising:
a coiled spring including a first end and a second end;
a protective coating disposed over said coiled spring, said protective coating being formed over and sealed with said coated spring, said protective coating including an overlapping portion having a length extending beyond each of said first end and said second end of said coiled spring so as to completely cover and seal with said coiled spring; and
said protective coating including an inner layer and an outer layer, said outer layer being resistant to chemicals and heat, said inner layer in contact with said coiled spring and being less resistant to heat than said outer layer and being sealable with said coiled spring.

2. A coated spring according to claim 1, wherein said coiled spring is constructed of a metal material being stress relievable and annealable with other materials upon subject to heat.

3. A coated spring according to claim 2, wherein said coiled spring is constructed of a stainless steel material.

4. A coated spring according to claim 1, wherein said protective coating and said portions of said protective coating being constructed of a dual heat shrinkable material.

5. A coated spring according to claim 1, wherein said inner layer being constructed of fluorinated ethylenepropylene.

6. A coated spring according to claim 1, wherein said outer layer being constructed of polytetrafluoroethylene.

7. A coated spring according to claim 1, wherein said protective coating being a tube having an opening longitudinally extending therethrough and including a length greater than a length of said coiled spring, said greater length being said overlapping portions of said first and second ends of said coiled spring.

8. A coated spring according to claim 1, wherein said overlapping portions of said protective coating being separately attached end caps disposed at said first and second ends of said coiled spring, said end caps being sealable with said ends of said coiled spring.

9. A coated spring according to claim 8, wherein said end caps disposed at said ends of said coiled spring forming a coated spring with a thickness at said ends being greater than a thickness between said ends.

10. A coated spring according to claim 1, wherein said length of said overlapping portions extending beyond said ends of said coiled spring being at least 0.5 inches.

11. A method for making a coated spring, comprising:
providing a wire spring material and a protective coating material, said protective coating material being a tube of an inner layer and an outer layer and being greater in length than said wire spring material, said protective coating having an opening longitudinally extending therethrough;
winding said wire spring material and said protective coating material in a same orientation;
threading said wire spring material into the protective coating material;
leaving a length extending beyond each end of said wire spring material;
heat shrinking said protective coating material onto said wire spring material; said heat shrinking forming a seal of said inner layer with said wire spring material and forming a protective layer with said outer layer,
wherein said protective coating material completely covers and seals with said wire spring material.

12. The method according to claim 11, wherein leaving said length extending beyond each end of said wire spring material including leaving a length of at least 0.5 inches so as to form overlapping portions at said ends of said wire spring material.

13. The method according to claim 11, wherein heat shrinking said protective coating including heating said protective coating at about 660° C. for up to 2 minutes, 45 seconds.

14. The method according to claim 11, wherein heat shrinking said protective coating including stress relieving said coated spring.

15. The method according to claim 11, further comprising trimming said ends of said protective coating material to a desired overlap length.

16. A method for making a coated spring, comprising:
providing a wire spring material and a protective coating material, said protective coating material being a tube of an inner layer and an outer layer, said protective coating having an opening longitudinally extending therethrough;
heat shrinking said protective coating material onto said wire spring material; said heat shrinking forming a seal of said inner layer with said wire spring material and forming a protective layer with said outer layer;
winding said protective coating material with said wire spring material threaded therein;
attaching a portion of a protective coating material at each exposed end of said wire spring material, said portions including an inner layer and an outer layer; and
performing a second heat shrinking of at least said portions of a protective coating material onto said ends of said wire spring material; said second heat shrinking forming a seal of said inner layer with said ends of said wire spring material and forming a protective layer over said ends with said outer layer, said heat shrunken portions including a length extending beyond said ends of said wire spring material;
wherein said protective coating material and said portions of a protective coating material completely cover and seal with said wire spring material.

17. The method according to claim 16, wherein said heat shrunken portions extending beyond each end of said wire spring material including leaving a length of at least 0.5 inches so as to form overlapping end caps at said ends of said wire spring material.

18. The method according to claim 16, wherein each heat shrinking step including heating said protective coating and said portions at about 660° C. for up to 2 minutes, 45 seconds.

19. The method according to claim 16, wherein heat shrinking said protective coating including stress relieving said coated spring.

20. The method according to claim 17, further comprising trimming said end caps to a desired overlap length of said end caps over said ends of said wire spring material.
